(19) United States
(12) Patent Application Publication
(10) Pub. No.: US 2021/0329938 A1
(43) Pub. Date: Oct. 28, 2021

(54) CANNABIS BEVERAGE COMPOSITIONS

(71) Applicant: Mikki West, York, ME (US)

(72) Inventor: Mikki West, York, ME (US)

(21) Appl. No.: 17/242,195

(22) Filed: Apr. 27, 2021

Related U.S. Application Data
(60) Provisional application No. 63/016,171, filed on Apr. 27, 2020.

(51) Int. Cl. A23F 3/14; A23L 33/105; A23L 29/00

(52) U.S. Cl. CPC A23F 3/14; A23L 29/035; A23L 33/105

(57) ABSTRACT

Disclosed herein are customizable Cannabis tea compositions.

### RELATED APPLICATIONS

This application claims the benefit of U.S. Provisional Application No. 63/016,171, filed on Apr. 27, 2020. The entire teachings of the above application are incorporated herein by reference.

### BACKGROUND OF THE INVENTION

Tea is one of the most popular beverages in the world, and in fact is the most widely consumed beverage after water. It has been recognized as having many numerous health benefits, such as providing antioxidants, reducing the risk of heart attack and stroke, assisting with weight loss, providing bone protection, decreasing tooth loss and erosion of tooth enamel, boosting the immune system, reducing the risk of cancer, and soothing the digestive system.

Cannabis has become increasingly popular for both recreational and medicinal uses. Cannabis is documented as providing relief from a variety of medical ailments including chronic pain, epilepsy, inflammation, and nausea resulting from chemotherapy. See, for example, Laura M. Borgelt et al., The Pharmacologic and Clinical Effects of Medical Cannabis, Pharmacotherapy (2013) 33(2): 195-209; Penny F. Whiting et al. Cannabinoids for Medical Use: A Systematic Review and Meta-Analysis, JAMA (2015) 313(24): 2456-2473, doi: 10.1001/jama.2015.6358.

Recently there has been an increase in the use of Cannabis in food and beverage products. However, an individual's sensitivity to Cannabis, as well as specific medical needs, will vary, and therefore there remains a need for customizable dosing with food and beverage.

### SUMMARY OF THE INVENTION

Disclosed herein are beverage compositions (e.g., tea beverages) infused with medical Cannabis or hemp (e.g., decarboxylated medical Cannabis or hemp). The tea, when in loose leaf tea form, can be packaged, for example, in a Lotus die cut packaging with a handmade origami dragonfly. In other aspects, the tea can be packaged in Calyx 25 dram containers, glass containers, or tin containers. In other aspects, the tea can be packaged in ePAC film tea sachets, where the film material may be a polyethylene terephthalate (PET), metallized PET, polyethylene (PE), recyclable PE, post consumer recycled (PCR) material, biaxially-oriented polypropylene (BOPP) blocking vapor material. The packaging material may further be moisture-resistant, aroma-resistant, oxygen-resistant, child-resistant, and/or recyclable. Each teabag further includes an origami dragonfly (e.g., a handmade origami dragonfly).

Disclosed herein are tea compositions comprising decarboxylated Cannabis and tea. In some embodiments, the decarboxylated Cannabis is provided in a tea bag, a tea sachet, or as a loose leaf. In some embodiments, the tea is provided in a tea bag, a tea sachet, or as a loose tea. In some aspects, the decarboxylated Cannabis and tea are packaged individually or in combination. In some aspects, the tea composition is a ready-to-drink beverage composition comprising the decarboxylated Cannabis and the tea.

In some embodiments, the decarboxylated Cannabis is selected from the group consisting of Cannabis indica, Cannabis sativa, and hybrid. The decarboxylated Cannabis may be a trim format, a flower format, and/or a kief format. In some embodiments, the Cannabis is Cannabis indica trim, Cannabis indica flower, Cannabis indica kief, Cannabis sativa trim, Cannabis sativa flower, Cannabis sativa kief, hybrid trim, hybrid flower, hybrid kief, or hemp (e.g., broad spectrum hemp or full spectrum hemp). In some embodiments, the decarboxylated Cannabis is provided as a Cannabis concentrate.

In some embodiments, the composition has about 3 mg to about 300 mg total cannabinoids, or about 100 mg to about 250 mg total cannabinoids, or about 115 mg to about 200 mg total cannabinoids. In some embodiments, the composition has about 10 mg to about 250 mg Δ⁹-tetrahydrocannabinol (THC), or about 75 mg to about 200 mg THC, or about 100 mg to 160 mg THC.

In some embodiments, the composition comprises about 40%-60% tea and about 40%-60% decarboxylated Cannabis or about 50% tea and about 50% decarboxylated Cannabis. In some embodiments, the composition comprises about 1 g tea and about 1 g decarboxylated Cannabis. In some embodiments, the composition is a ready-to-drink tea beverage comprising about 5 to 10 oz of tea and about 1 g decarboxylated Cannabis.

In some embodiments, the tea is one or more teas selected from the group consisting of white tea, yellow tea, green tea, matcha tea (e.g., ceremonial matcha tea), oolong tea, black tea, post-fermented (dark) tea, milk tea, and herbal tea.

In some embodiments, the composition is in the form of a loose leaf tea or a tea bag. In some embodiments, the composition is a ready-to-drink tea beverage (e.g., a ready-to-drink milk or green boba tea). In some embodiments, the composition further includes boba balls, e.g., Cannabis infused boba balls or non-Cannabis infused boba balls.

### DETAILED DESCRIPTION OF THE INVENTION

Cannabis is a genus of flowering plants in the family Cannabaceae. Within the genus there are three species: Cannabis sativa, Cannabis indica, and Cannabis ruderalis. Within each species there are a wide variety of unique strains. In addition, there is a hybrid species that is a hybrid of Cannabis sativa and Cannabis indica. Unique strains of the hybrid species will include different percentages of Cannabis sativa and Cannabis indica (e.g., a hybrid strain may be sativa dominant, i.e., having a higher percentage of sativa, or indica dominant, i.e., having a higher percentage of indica).

Cannabis plants produce a unique family of terpeno-phenolic compounds called cannabinoids. There are 483 identifiable chemical constituents known to exist in the Cannabis plant, and at least 85 different cannabinoids have been isolated from the plant. The two cannabinoids usually produced in greatest abundance are cannabidiol (CBD) and/or Δ⁹-tetrahydrocannabinol (THC). Cannabis plants are categorized by their chemical phenotype or “chemotype”, based on the overall amount of THC produced, and on the ratio of THC to CBD. Cannabinoids have been investigated for possible treatment of seizures, nausea, vomiting, lack of appetite, pain, arthritis, inflammation, post traumatic stress disorder, anxiety, autism, neurological disorders, and other conditions.

Cannabinoids may be found in varying concentrations throughout the marijuana plant. For example, kief, which are the resin glands that contain terpenes and cannabinoids, (also known as dry sift or pollen), has a higher concentration of cannabinoids than trim (i.e., the excess snipping of outer sugar leaves from buds of the plant), and the flower or bud may have a higher concentration of cannabinoids than the trim.

Disclosed herein is a Cannabis beverage composition. In some embodiments, a Cannabis beverage composition comprises Cannabis sativa, Cannabis indica, or hybrid. Numerous strains of Cannabis are known to those of skill in the art and may be found listed at.leafly.com/strains. Any strain or combination of strains may be used in the beverage compositions. In certain embodiments, the Cannabis is medical Cannabis. Non-limiting examples of strains that may be used include Apollo 11, Blue Dream, Blue Power, Cinderella 99, Girl Scout Cookies, Durban Princess, Critical Purple Kush, Northern Lights, Strawberry Banana, White Siberian, Durban Thai, Pakistani Afghan Kush, Tangerine Dream, Sour Diesel, and Alien Dog. In some embodiments, the Cannabis is hemp. The hemp may be full spectrum hemp (e.g., contains all cannabinoids) or broad spectrum hemp (e.g., lacking THC). In some embodiments, the Cannabis beverage comprises Cannabis in trim format, kief format, or flower format. In some aspects, the Cannabis is provided as a concentrate. In certain aspects, a Cannabis beverage comprises Cannabis indica in trim format, kief format, or flower format. In other embodiments, a Cannabis beverage comprises Cannabis sativa in trim format, kief format, or flower format. In other embodiments, a Cannabis beverage comprises a Cannabis hybrid in trim format, kief format, or flower format. In one embodiment, the Cannabis is decarboxylated. In one embodiment, the Cannabis is provided as a THC extract. In some aspects, a Cannabis beverage comprises Cannabis (e.g., a THC extract) in a form selected from the group consisting of: badder, batter, and/or budder; Cannabis flower essential oil; caviar or moon rocks (e.g., Cannabis buds dipped in or sprayed with hash oil, and optionally rolled in kief); crumble; crystalline; distillate; dry sift; hashish or hash (e.g., a Cannabis concentrate traditionally made by drying the Cannabis plant and beating the dried female plant material over a series of screens and sifting, collecting, and pressing the particles); bubble hash (e.g., water-purified hashish); charas (e.g., Cannabis concentrate created by expressing the flower of Cannabis indica between the hands and removing the residue); hash oil; fully extracted Cannabis oil (FECO); butane hash oil (BHO); CO2 oil; honeycomb; kief; live resin; pull and snap; rosin; shatter; taffy; terp sauce; tincture of Cannabis; and wax.

The varying concentrations of cannabinoids found within the kief, trim, and flower allows for beverage compositions to be designed to have varying potency levels based on the Cannabis format selected. For example, a beverage composition comprising a strain of Cannabis in kief format may be more potent (e.g., have a higher total cannabinoid concentration) than a beverage composition comprising the same strain of Cannabis in trim or flower format.

In some embodiments, the beverage composition is a tea or coffee beverage. In some aspects, the Cannabis is combined with one or more of a white tea, yellow tea, green tea, oolong tea, black tea, post-fermented (dark) tea, or herbal tea. Herbal teas include infusions of fruit, leaves, or other parts of the plant, such as steeps of rosehip, chamomile, or rooibos. In another aspect, yerba mate ground leaf is used as a tea. In some embodiments, the beverage composition is a milk tea. In other aspects, the Cannabis is combined with a coffee.

In some aspects, the beverage composition further comprises supplemental flavors. Tea flavors are typically created using herbs or plant matters from spice plants. Tea flavors used in these embodiments may be chosen from a group comprising of orange, citrus, blueberry, raspberry, apple, strawberry, rose, jasmine, berry, osmanthus, chrysanthemum, lotus, mint, pandan, smoke, spices (such as ginger, cardamom, cinnamon, cassia, black pepper, clove, anise, fennel, Indian bay leaf, vanilla, nutmeg, or mace), rum, roasted grains and nuts, among other flavors. Flavors may also be added by adding essential oils into loose tea leaf.

In some embodiments, the beverage composition further comprises sweeteners. For example, the sweetener may be derived from sugar, artificial sweetener and natural sweetener. In some embodiments, the beverage composition further comprises milk. The milk may be any form readily available including goat milk, oat milk, cows milk, or a nut milk (e.g., soy, almond, cashew, etc.).

The beverage compositions described herein may be provided as a loose leaf tea, pre-measured/packaged tea bags, or as a pre-made, ready-to-drink beverage. In some aspects a ready-to-drink beverage is a hot brewed or cold brewed tea. In other aspects a ready-to-drink beverage is a hot brewed or cold brewed coffee. In some aspects, a ready-to-drink beverage is a boba tea. For example, a tea described herein (e.g., milk tea, black tea, green tea, etc.) may be combined with decarboxylated Cannabis and boba.

In some embodiments, the tea can be packaged in Calyx 25 dram containers, glass containers, or tin containers. In other aspects, the tea can be packaged in ePAC film tea sachets, where the film material may be a polyethylene terephthalate (PET), metallized PET, polyethylene (PE), recyclable PE, post consumer recycled (PCR) material, biaxially-oriented polypropylene (BOPP) blocking vapor material. The packaging material may further be moisture-resistant, aroma-resistant, oxygen-resistant, child-resistant, and/or recyclable.

In some embodiments, a beverage composition is a pre-measured and pre-packaged tea bag. Each tea bag may comprise the desired Cannabis strain and format. Other teas may be included, such as a green tea (e.g., ceremonial matcha tea). In some aspects, each tea bag comprises about 0.1 mg to about 500 mg, or about 10 mg to about 300 mg, about 25 mg to about 250 mg, or about 50 mg to about 200 mg total cannabinoids. In certain aspects, each tea bag comprises about 110 mg to about 125 mg, about 155 mg to about 170 mg, or about 165 mg to about 180 mg total cannabinoids. In certain aspects, each tea bag comprises about 0.1 mg to about 50 mg or about 10 mg to about 30 mg total cannabinoids. In some aspects, each tea bag comprises about 0.1 mg, 0.2 mg, 0.3 mg, 0.4 mg, 0.5 mg, 0.6 mg, 0.7 mg, 0.8 mg, 0.9 mg, 1.0 mg, 10 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, 425 mg, 450 mg, 475 mg, or 500 mg total cannabinoids.

In some aspects, each tea bag comprises about 0.1 mg to about 500 mg, about 10 mg to about 300 mg, about 25 mg to about 250 mg, or about 50 mg to 200 mg THC. In certain aspects, each tea bag comprises about 100 mg to about 115 mg, about 140 mg to about 155 mg, or about 150 mg to about 165 mg THC. In certain aspects, each tea bag comprises about 0.1 mg to about 100 mg, about 10 mg to about 70 mg, or about 20 mg to about 30 mg THC. In some aspects, each tea bag comprises about 0.1 mg, 0.2 mg, 0.3 mg, 0.4 mg, 0.5 mg, 0.6 mg, 0.7 mg, 0.8 mg, 0.9 mg, 1.0 mg, 10 mg, 25 mg, 50 mg, 75 mg, 100 mg, 125 mg, 150 mg, 175 mg, 200 mg, 225 mg, 250 mg, 275 mg, 300 mg, 325 mg, 350 mg, 375 mg, 400 mg, 425 mg, 450 mg, 475 mg, or 500 mg total THC.

In some embodiments, the beverage compositions comprise about 1%-99% by weight tea and about 1%-99% by weight Cannabis. In some embodiments, the beverage compositions comprise about 10%, 20%, 30%, 40%, 50%, 60%, 70%, 80%, or 90% by weight tea and about 10%, 20%, 30%, 40%, 50%, 60%, 70%, 80%, or 90% by weight Cannabis (e.g., decarboxylated Cannabis). In certain embodiments, the beverage compositions comprise about 40-60% by weight tea about 40%-60% by weight Cannabis, e.g., about 50% by weight tea (e.g., black tea, green tea, matcha tea, milk tea, etc.) and about 50% by weight Cannabis (e.g., decarboxylated Cannabis). In some aspects, the beverage composition is a tea bag comprising about ±1 g tea and about ±1 g decarboxylated Cannabis. In some aspects, the beverage composition is a tea bag comprising about 1 g tea and about 1 g decarboxylated Cannabis. In some aspects, the beverage composition is a ready-to-drink beverage comprising about ±1 g tea and about ±1 g decarboxylated Cannabis, and optionally further includes boba (e.g., boba balls), other flavors, or additional additives (e.g., milk, sugar, stabilizers, etc.). In some aspects, the beverage composition is a ready-to-drink beverage comprising about 1 g tea and about 1 g decarboxylated Cannabis, and optionally further includes boba (e.g., boba balls), other flavors, or additional additives (e.g., milk, sugar, stabilizers, etc.). Boba balls may be formed comprising tapioca flour, brown sugar, hot water, and optionally Cannabis (e.g., a Cannabis concentrate).

In some embodiments, an individual selects a beverage composition for ingestion based on the Cannabis strain included. For example, an individual may choose a beverage composition, e.g., a Cannabis tea, based on the concentration of THC in the tea bag. One tea bag may be brewed, for example, in 6 ounces of water. Upon brewing the tea, the individual may then dose themselves as appropriate, e.g., may drink 2 oz of the tea in the morning, 2 oz of the tea in the afternoon, and 2 oz of the tea in the evening.

The beverage compositions disclosed herein may be used by an individual to treat seizures, nausea, vomiting, lack of appetite, pain, arthritis, inflammation, post-traumatic stress disorder, anxiety, autism, neurological disorders, among other conditions.

### EXAMPLES

Example 1: A tea bag comprising about 1 g green tea and about 1 g decarboxylated Durban Thai trim (e.g., having a total cannabinoid concentration of about 118 mg).
Example 2: A tea bag comprising about 1 g green tea and about 1 g decarboxylated Northern Lights flower (e.g., having a total cannabinoid concentration of about 172 mg).
Example 3: A tea bag comprising about 1 g green tea and about 1 g decarboxylated Sour Power kief (e.g., having a total cannabinoid concentration of about 230 mg).
Example 4: A tea bag comprising about 1 g green tea and about 1 g decarboxylated White Siberian flower (e.g., having a total cannabinoid concentration of about 118 mg).
Example 5: A tea bag comprising about 1 g green tea and about 1 g decarboxylated Strawberry Banana kief (e.g., having a THC concentration of about 159 mg).
Example 6: A tea bag comprising about 1 g green tea and about 1 g decarboxylated Northern Lights trim (e.g., having a THC concentration of about 24 mg).
Example 7: A tea bag comprising about 1 g green tea and about 1 g decarboxylated Sour Power kief (e.g., having a THC concentration of about 64 mg).
Example 8: A tea bag comprising about 1 g decarboxylated Durban Thai trim (e.g., having a total cannabinoid concentration of about 118 mg), added separately to a beverage about 1 g ceremonial matcha tea.
Example 9: A tea bag comprising about 1 g decarboxylated Northern Lights flower (e.g., having a total cannabinoid concentration of about 172 mg), added separately to a beverage about 1 g ceremonial matcha tea.
Example 10: A tea bag comprising about 1 g decarboxylated Sour Power kief (e.g., having a total cannabinoid concentration of about 230 mg), added separately to a beverage about 1 g ceremonial matcha tea.
Example 11: A tea bag comprising about 1 g decarboxylated White Siberian flower (e.g., having a total cannabinoid concentration of about 118 mg), added separately to a beverage about 1 g ceremonial matcha tea.
Example 12: A tea bag comprising about 1 g decarboxylated Strawberry Banana kief (e.g., having a THC concentration of about 159 mg), added separately to a beverage about 1 g ceremonial matcha tea.
Example 13: A tea bag comprising about 1 g decarboxylated Northern Lights trim (e.g., having a THC concentration of about 24 mg), added separately to a beverage about 1 g ceremonial matcha tea.
Example 14: A tea bag comprising about 1 g decarboxylated Sour Power kief (e.g., having a THC concentration of about 64 mg), added separately to a beverage about 1 g ceremonial matcha tea.
Example 15: A ready-to-drink beverage comprising about 6 oz green tea, about 1 g decarboxylated Durban Thai trim (e.g., having a total cannabinoid concentration of about 118 mg), and about ⅓ cup boba balls.
Example 16: A ready-to-drink beverage comprising about 6 oz green tea, about 1 g decarboxylated Northern Lights flower (e.g., having a total cannabinoid concentration of about 172 mg), and about ⅓ cup boba balls.
Example 17: A ready-to-drink beverage comprising about 6 oz green tea, about 1 g decarboxylated Sour Power kief (e.g., having a total cannabinoid concentration of about 230 mg), and about ⅓ cup boba balls.
Example 18: A ready-to-drink beverage comprising about 6 oz green tea, about 1 g decarboxylated White Siberian flower (e.g., having a total cannabinoid concentration of about 118 mg), and about ⅓ cup boba balls.
Example 19: A ready-to-drink beverage comprising about 6 oz green tea and about 1 g decarboxylated Strawberry Banana (e.g., having a THC concentration of about 158 mg), and about ⅓ cup boba balls.
Example 20: A ready-to-drink beverage comprising about 6 oz green tea and about 1 g decarboxylated Northern Lights trim (e.g., having a THC concentration of about 24 mg), and about ⅓ cup boba balls.
Example 21: A ready-to-drink beverage comprising about 6 oz green tea and about 1 g decarboxylated Sour Power kief (e.g., having a THC concentration of about 64 mg), and about ⅓ cup boba balls.
Example 22: A ready-to-drink beverage comprising about 6 oz ceremonial matcha tea, about 1 g decarboxylated Durban Thai trim (e.g., having a total cannabinoid concentration of about 118 mg), and about ⅓ cup boba balls.
Example 23: A ready-to-drink beverage comprising about 6 oz ceremonial matcha tea, about 1 g decarboxylated Northern Lights flower (e.g., having a total cannabinoid concentration of about 172 mg), and about ⅓ cup boba balls.
Example 24: A ready-to-drink beverage comprising about 6 oz ceremonial matcha tea, about 1 g decarboxylated Sour Power kief (e.g., having a total cannabinoid concentration of about 230 mg), and about ⅓ cup boba balls.
Example 25: A ready-to-drink beverage comprising about 6 oz ceremonial matcha tea, about 1 g decarboxylated White Siberian flower (e.g., having a total cannabinoid concentration of about 118 mg), and about ⅓ cup boba balls.
Example 26: A ready-to-drink beverage comprising about 6 oz ceremonial matcha tea and about 1 g decarboxylated Strawberry Banana (e.g., having a THC concentration of about 158 mg), and about ⅓ cup boba balls.
Example 27: A ready-to-drink beverage comprising about 6 oz ceremonial matcha tea and about 1 g decarboxylated Northern Lights trim (e.g., having a THC concentration of about 24 mg), and about ⅓ cup boba balls.
Example 28: A ready-to-drink beverage comprising about 6 oz ceremonial matcha tea and about 1 g decarboxylated Sour Power kief (e.g., having a THC concentration of about 64 mg), and about ⅓ cup boba balls.
Example 29: A ready-to-drink beverage comprising about 6 oz milk tea, about 1 g decarboxylated Durban Thai trim (e.g., having a total cannabinoid concentration of about 118 mg), and about ⅓ cup boba balls.
Example 30: A ready-to-drink beverage comprising about 6 oz milk tea, about 1 g decarboxylated Northern Lights flower (e.g., having a total cannabinoid concentration of about 172 mg), and about ⅓ cup boba balls.
Example 31: A ready-to-drink beverage comprising about 6 oz milk tea, about 1 g decarboxylated Sour Power kief (e.g., having a total cannabinoid concentration of about 162 mg), and about ⅓ cup boba balls.
Example 32: A ready-to-drink beverage comprising about 6 oz milk tea, about 1 g decarboxylated White Siberian flower (e.g., having a total cannabinoid concentration of about 118 mg), and about ⅓ cup boba balls.
Example 33: A ready-to-drink beverage comprising about 6 oz milk tea and about 1 g decarboxylated Strawberry Banana (e.g., having a THC concentration of about 158 mg), and about ⅓ cup boba balls.
Example 34: A ready-to-drink beverage comprising about 6 oz milk tea and about 1 g decarboxylated Northern Lights trim (e.g., having a THC concentration of about 24 mg), and about ⅓ cup boba balls.
Example 35: A ready-to-drink beverage comprising about 6 oz milk tea and about 1 g decarboxylated Sour Power kief (e.g., having a THC concentration of about 64 mg), and about ⅓ cup boba balls.
Example 36: A tea bag composition comprising about 1 g green tea and about 1 g decarboxylated broad spectrum hemp.
Example 37: A tea bag composition comprising about 1 g green tea and about 1 g decarboxylated full spectrum hemp.
Example 38: A tea bag composition comprising about 1 g decarboxylated broad spectrum hemp, added separately about 1 g ceremonial matcha.
Example 39: A tea bag composition comprising about 1 g decarboxylated full spectrum hemp, added separately about 1 g ceremonial matcha.
Example 40: A ready-to-drink beverage comprising about 6 oz green tea, about 1 g decarboxylated broad spectrum hemp, and about ⅓ cup boba balls.
Example 41: A ready-to-drink beverage comprising about 6 oz green tea, about 1 g decarboxylated full spectrum hemp, and about ⅓ cup boba balls.
Example 42: A ready-to-drink beverage comprising about 6 oz milk tea, about 1 g decarboxylated broad spectrum hemp, and about ⅓ cup boba balls.
Example 43: A ready-to-drink beverage comprising about 6 oz milk tea, about 1 g decarboxylated full spectrum hemp, and about ⅓ cup boba balls.
Example 44: A ready-to-drink beverage comprising about 6 oz ceremonial matcha tea, about 1 g decarboxylated broad spectrum hemp, and about ⅓ cup boba balls.
Example 45: A ready-to-drink beverage comprising about 6 oz ceremonial match tea, about 1 g decarboxylated full spectrum hemp, and about ⅓ cup boba balls.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or prior publication, or for any other reason. All statements as to the date or representation as to the contents of these documents is based on the information available to the applicants and does not constitute any admission as to the correctness of the dates or contents of these documents.

One skilled in the art readily appreciates that the present invention is well adapted to carry out the objects and obtain the ends and advantages mentioned, as well as those inherent therein. The details of the description and the examples herein are representative of certain embodiments, are exemplary, and are not intended as limitations on the scope of the invention. Modifications therein and other uses will occur to those skilled in the art. These modifications are encompassed within the spirit of the invention. It will be readily apparent to a person skilled in the art that varying substitutions and modifications may be made to the invention disclosed herein without departing from the scope and spirit of the invention.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. It is contemplated that all embodiments described herein are applicable to all different aspects of the invention where appropriate. It is also contemplated that any of the embodiments or aspects can be freely combined with one or more other such embodiments or aspects whenever appropriate. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. For example, any one or more active agents, additives, ingredients, optional agents, types of organism, disorders, subjects, or combinations thereof, can be excluded.

Where the claims or description relate to a composition of matter, it is to be understood that methods of making or using the composition of matter according to any of the methods disclosed herein, and methods of using the composition of matter for any of the purposes disclosed herein are aspects of the invention, unless otherwise indicated or unless it would be evident to one of ordinary skill in the art that a contradiction or inconsistency would arise. Where the claims or description relate to a method, e.g., it is to be understood that methods of making compositions useful for performing the method, and products produced according to the method, are aspects of the invention, unless otherwise indicated or unless it would be evident to one of ordinary skill in the art that a contradiction or inconsistency would arise.

Where ranges are given herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. It is also understood that where a series of numerical values is stated herein, the invention includes embodiments that relate analogously to any intervening value or range defined by any two values in the series, and that the lowest value may be taken as a minimum and the greatest value may be taken as a maximum. Numerical values, as used herein, include values expressed as percentages. For any embodiment of the invention in which a numerical value is prefaced by “about” or “approximately”, the invention includes an embodiment in which the exact value is recited. For any embodiment of the invention in which a numerical value is not prefaced by “about” or “approximately”, the invention includes an embodiment in which the value is prefaced by “about” or “approximately”.

“Approximately” or “about” generally includes numbers that fall within a range of 1% or in some embodiments within a range of 5% of a number or in some embodiments within a range of 10% of a number in either direction (greater than or less than the number) unless otherwise stated or otherwise evident from the context (except where such number would impermissibly exceed 100% of a possible value). It should be understood that, unless clearly indicated to the contrary, in any methods claimed herein that include more than one act, the order of the acts of the method is not necessarily limited to the order in which the acts of the method are recited, but the invention includes embodiments in which the order is so limited.

What is claimed is:

1. A tea composition comprising decarboxylated Cannabis and tea.

2. The composition of claim 1, wherein the decarboxylated Cannabis is selected from the group consisting of Cannabis indica, Cannabis sativa, and hybrid.

3. The composition of claim 1, wherein the decarboxylated Cannabis is a trim format, a flower format, or a kief format.

4. The composition of claim 1, wherein the decarboxylated Cannabis is Cannabis indica trim, Cannabis indica flower, or Cannabis indica kief.

5. The composition of claim 1, wherein the decarboxylated Cannabis is Cannabis sativa trim, Cannabis sativa flower, or Cannabis sativa kief.

6. The composition of claim 1, wherein the decarboxylated Cannabis is hybrid trim, hybrid flower, or hybrid kief.

7. The composition of claim 1, wherein the decarboxylated Cannabis is hemp.

8. The composition of claim 7, wherein the hemp is broad spectrum hemp or full spectrum hemp.

9. The composition of claim 1, wherein the tea is selected from the group consisting of white tea, yellow tea, green tea, matcha tea, oolong tea, black tea, post-fermented (dark) tea, milk tea, and herbal tea.

10. The composition of claim 1, wherein the composition has about 3 mg to about 300 mg total cannabinoids.

11. The composition of claim 1, wherein the composition has about 50 mg to about 250 mg total cannabinoids.

12. The composition of claim 1, wherein the composition has about 10 mg to about 250 mg Δ⁹-tetrahydrocannabinol (THC).

13. The composition of claim 1, wherein the composition has about 75 mg to about 200 mg THC.

14. The composition of claim 1, wherein the composition comprises about 40%-60% tea and about 40%-60% decarboxylated Cannabis.

15. The composition of claim 1, wherein the composition comprises about 50% tea and about 50% decarboxylated Cannabis.

16. The composition of claim 1, wherein the composition comprises about 1 g tea and about 1 g decarboxylated Cannabis.

17. The composition of claim 1, wherein the composition is a ready-to-drink tea beverage.

18. A ready-to-drink tea beverage comprising decarboxylated Cannabis concentrate and tea.

19. The ready-to-drink tea beverage of claim 18, wherein the decarboxylated Cannabis is selected from the group consisting of Cannabis indica, Cannabis sativa, and hybrid.

20. The ready-to-drink tea beverage of claim 18, wherein the decarboxylated Cannabis is hemp.
